(19) United States
(12) Patent Application Publication
(10) Pub. No.: US 2025/0340680 A1
(43) Pub. Date: Nov. 6, 2025

(54) CO-AGENT ASSISTED FORMATION OF CROSSLINKED SILICON-POLYOLEFIN INTERPOLYMER UTILIZING CROSSLINK AGENT

(71) Applicant: Dow Global Technologies LLC, Midland, MI (US)

(72) Inventors: Ryan Maar, Midland, MI (US); Zachary S. Kean, Midland, MI (US); Shuqi Lai, Midland, MI (US); David S. Laitar, Midland, MI (US); Jordan C. Reddel, Midland, MI (US)

(21) Appl. No.: 18/868,504

(22) PCT Filed: May 22, 2023
(86) PCT No.: PCT/US2023/023125

§ 371 Date: Nov. 22, 2024

Related U.S. Application Data
(60) Provisional application No. 63/347,123, filed on May 31, 2022.

(51) Int. Cl. C08F 8/10; C08K 5/17

(52) U.S. Cl. CPC C08F 8/10; C08K 5/17; C08F 2810/20; C08F 2810/50

(57) ABSTRACT

The present disclosure provides a process. In an embodiment, the process includes melt blending, at a temperature from 80° C. to 200° C., a composition composed of (i) an ethyl-ene-SiH polymer, (ii) a crosslink agent that is 1,3-dibenzoylpropane, (iii) a triarylborane, and (iv) an alkylamine inhibitor. The process further includes forming a crosslinked ethylene-Si polymer. The present disclosure also provides crosslinked ethylene-Si polymer composition composed from the present process.

Crosslinked polyolefins (such as crosslinked polyethylene, for example) are known to possess superior mechanical properties compared to their uncrosslinked counterparts, which leads to improved performance in their end-use.

One common approach to crosslink a polyolefin entails processing steps to functionalize the polyolefin. The functionalized polyolefin is then subjected to a crosslinking step that requires an initiator such as a peroxide or a condensation catalyst.

Another common approach to cure polyolefin materials (such as polyethylene) is moisture cure. Moisture cure entails installing a hydrolysable functional group, such as vinyltrimethoxysilane (VTMS), onto polyethylene and subsequently exposing the functionalized polyethylene to moisture. However, cure of such material requires penetration of moisture into the material, which limits the cure rate and may cause nonuniform cure throughout thickness of the material. Meanwhile, moisture cure often requires specific setup like a humidity chamber or a sauna room. Moisture cure of polyolefin material typically occurs over the course of several days or weeks. The reliance of the cure process on moisture diffusion often leads to nonuniform cure throughout the thickness of the materials and makes full cure of a thick part challenging.

Given the continuous growth in applications for crosslinked polyolefins, the art recognizes the on-going need for new processes for crosslinking polyethylene and new processes for forming crosslinked polyethylene that is degradable and/or recyclable.

### SUMMARY

The present disclosure provides a process. In an embodiment, the process includes melt blending, at a temperature from 80° C. to 200° C., a composition composed of (i) an ethylene-SiH polymer, (ii) a crosslink agent that is 1,3-dibenzoylpropane, (iii) a triarylborane, and (iv) an alkylamine inhibitor. The process further includes forming a crosslinked ethylene-Si polymer.

The present disclosure provides a composition. In an embodiment, the composition includes a crosslinked ethylene-Si polymer having a Structure (1)

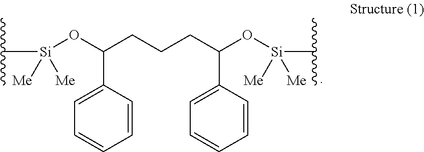 [SMILES: *[Si](C)(C)OC(CCCC(O[Si](*)(C)C)c1ccccc1)c1ccccc1]

Applicant discovered that upon heating, the alkylamine inhibitor breaks down and releases the triaryl borane as catalyst to react with the ethylene-SiH polymer and the crosslink agent (which is a di-functional crosslink agent) yielding a crosslinked network. Without the alkylamine inhibitor, the crosslinking reaction is uncontrollable leading to a loss of processability, which is detrimental to producing a finished part. The resultant Si—O—C linkage may be degradable enabling recyclability for the crosslinked ethylene-Si polymer. Applicant further discovered that the temperature to produce crosslinking was tunable based on the identity of the alkylamine inhibitor used.

### BRIEF DESCRIPTION OF THE DRAWINGS

FIG. 1(a) and FIG. 1(b) are graphs showing respective MDR profiles of FIG. 1(a) with 1,3-DBP and 100 ppm FAB inhibited with 1.2 eqv NEt₃ (IE1) and FIG. 1(b) 1,3-DBP and 50 ppm FAB inhibited by 1.2 eqv. NEt₃ (IE2) at different temperatures, in accordance with embodiments of the present disclosure.

FIG. 2 is a graph showing SiH conversion of 1,3-DBP samples containing (i) no FAB, (ii) 100 ppm FAB (IE1), and (iii) 50 ppm FAB (IE2), each inhibited by 1.2 eqv. NEt₃ after 30 minutes at different cure temperatures, in accordance with embodiments of the present disclosure. The datapoints at 100° C. represent SiH conversions in the as-compounded samples that were blended at 100° C. for 5 minutes.

FIG. 3 is a graph showing MDR profiles of 1,3-DBP samples containing 100 ppm FAB inhibited by 1.2 eqv. iPr₂NH (IE3) at different temperatures, in accordance with embodiments of the present disclosure.

FIG. 4 is a graph showing SiH conversion of a 1,3-DBP sample containing 100 ppm FAB inhibited by 1.2 eqv. iPr₂NH (IE3) at different temperatures. The datapoint at 100° C. represents the SiH conversion in the as-compounded sample that was blended at 100° C. for 5 minutes.

FIG. 5 is a graph showing MDR profiles of 1,3-DBP samples containing 100 ppm FAB inhibited by 1.2 eqv. Pr₂NH (IE4) at different temperatures, in accordance with embodiments of the present disclosure.

FIG. 6 is a graph showing SiH conversion of a 1,3-DBP sample containing 100 ppm FAB inhibited by 1.2 eqv. Pr₂NH (IE4) after 30 minutes at different temperatures, in accordance with embodiments of the present disclosure. The datapoint at 100° C. represent the SiH conversion in the as-compounded sample that was blended at 100° C. for 5 minutes.

FIG. 7 is a graph showing MDR profiles of 1,3-DBP samples containing 100 ppm FAB inhibited by 1.2 eqv. tOA (IE5) at different temperatures, in accordance with embodiments from the present disclosure.

FIG. 8 is a graph showing SiH conversion of a 1,3-DBP sample containing 100 ppm FAB inhibited by 1.2 eqv. tOA (IE5) after 30 minutes at different temperatures, in accordance with embodiments of the present disclosure. The datapoint at 100° C. represent the SiH conversion in the as-compounded sample that was blended at 100° C. for 5 minutes.

FIG. 9(a) and FIG. 9(b) are graphs showing MDR profiles of 1,3-DBP samples containing (a) 100 ppm FAB (IE6) and (b) 500 ppm FAB (IE7), each inhibited by 1.2 eqv. nOA at different temperatures, in accordance with embodiments of the present disclosure.

FIG. 10 is a graph showing SiH conversion of 1,3-DBP samples containing 100 ppm FAB (IE6) and 500 ppm FAB (IE7), each inhibited by 1.2 eqv. nOA after 30 minutes at different temperatures. The datapoints at 100° C. represent SiH conversions in the as-compounded samples that were blended at 100° C. for 5 minutes.

FIG. 11 is a graph showing the MDR profiles of 1,3-DBP samples containing 100 ppm FAB inhibited by 1.2 eqv. Pip (CS2), TMP (CS4), and DMP (CS3) at 180° C.

FIG. 12 is a graph showing the MDR profiles of 1,3-DBP samples containing 100 ppm FAB inhibited by 1.2 eqv. 2-AH (CS5) at different temperatures.

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 or 2, or 3 to 5, or 6, or 7), any subrange between any two explicit values is included (e.g., the range 1-7 above includes subranges of 1 to 2; 2 to 6; 5 to 7; 3 to 7; 5 to 6; etc.).

Unless stated to the contrary, implicit from the context, or customary in the art, all parts and percents are based on weight, and all test methods are current as of the filing date of this disclosure.

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

A “Dalton” is the unit for the molecular weight of a polymer and is equivalent to an atomic mass unit, with abbreviation “Da,” or “kDa” (kilo Dalton).

An “ethylene-based polymer” or “ethylene polymer” is a polymer that contains a majority amount of polymerized ethylene based on the weight of the polymer and, optionally, may comprise at least one comonomer. Ethylene-based polymers typically comprise at least 50 mole percent (mol %) units derived from ethylene (based on the total amount of polymerizable monomers).

A “hydrocarbon” (or, “hydrocarbyl” a “hydrocarbyl group”) is a compound containing only hydrogen atoms and carbon atoms.

The terms “heterohydrocarbon,” (“heterohydrocarbyl,” or heterohydrocarbyl group”) and similar terms, as used herein, refer to a respective hydrocarbon, in which at least one carbon atom is substituted with a heteroatom group (for example, Si, O, N or P).

The terms “substituted hydrocarbon,” (or “substituted hydrocarbyl,” or “substituted hydrocarbyl group”) refers to a hydrocarbon in which one or more hydrogen atoms is/are independently substituted with a heteroatom group. The terms “substituted heterohydrocarbon,” (“substituted heterohydrocarbyl,” or “substituted heterohydrocarbyl group”) and similar terms, as used herein, refer to a respective heterohydrocarbon in which one or more hydrogen atoms is/are independently substituted with a heteroatom group.

An “interpolymer” is a polymer prepared by the polymerization of at least two different types of monomers. The generic term interpolymer thus includes copolymers (employed to refer to polymers prepared from two different types of monomers), and polymers prepared from more than two different types of monomers.

An “olefin-based polymer” or “polyolefin” is a polymer that contains a majority mole percent polymerized olefin monomer (based on total amount of polymerizable monomers), and optionally, may contain at least one comonomer. Nonlimiting examples of olefin-based polymer include ethylene-based polymer and propylene-based polymer. Representative polyolefins include polyethylene, polypropylene, polybutene, polyisoprene and their various interpolymers.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” as defined hereinafter. Trace amounts of impurities, for example, catalyst residues, may be incorporated into and/or within the polymer. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “propylene-based polymer” is a polymer that contains a majority amount of polymerized propylene based on the weight of the polymer and, optionally, may comprise at least one comonomer. Propylene-based polymers typically comprise at least 50 mole percent (mol %) units derived from propylene (based on the total amount of polymerizable monomers).

### Test Methods

Density is measured in accordance with ASTM D792, Method B (g/cc org/cm³).

Differential Scanning Calorimetry (DSC). Differential Scanning Calorimetry (DSC) is used to measure Tm, Tc, Tg and crystallinity in ethylene-based polymer samples. About 5 to 8 mg of sample was weighed and placed in a DSC pan. The lid was crimped on the pan to ensure a closed atmosphere. Unless otherwise stated, the sample pan was placed in a DSC cell, and then heated, at a rate of 10° C./min, to a temperature of 200° C. The sample was kept at this temperature for three minutes. Then the sample was cooled at a rate of 10° C./min to −90° C., and kept isothermally at that temperature for three minutes. The sample was next heated at a rate of 10° C./min, until complete melting (second heat). Unless otherwise stated, melting point (Tm) and the glass transition temperature (Tg) of each polymer were determined from the second heat curve. The peak heat flow temperature for the Tm was recorded.

FTIR-ATR. Infrared spectra were collected on a Perkin Elmer Frontier Fourier-transform infrared spectrometer (FT-IR) with attenuated total reflection (ATR) accessory (single bounce diamond/ZnSe). Samples were cut with scissors to reveal a clean interior surface, then placed into the accessory and held at a force where the peak absorbance is approximately 0.4 and 4-16 scans were collected depending on spectrum quality. Spectra was collected in at least triplicate to ensure representative sampling of the entire sample. SiH conversion. SiH conversion is the mol % of SiH bonds in the ethylene-SiH polymer that become Si—C bonds (“SiC”) as a result of the hydrosilation reaction. SiH conversion was determined by normalizing the peak at 2920 cm⁻¹ and setting the baseline to zero at 942 cm⁻¹, the Si—H peak at 887 cm⁻¹ was then used to determine conversion. % SiH Conversion=100*(Absorbance at 887 cm⁻¹ afterthe hydrosilation reaction)/(Absorbance at 887 cm⁻¹ before the hydrosilation reaction).

Gel content is measured by overnight hot extraction with xylene in accordance with ASTM D2765-16.

Gel permeation chromatography. The chromatographic system consisted of a PolymerChar GPC-IR (Valencia, Spain) high temperature GPC chromatograph, equipped with an internal IR5 infra-red detector (IR5). The autosampler oven compartment was set at 1602 Celsius, and the column compartment was set at 1502 Celsius. The columns were one Agilent PLgel MIXED 7.5×50 mm, 20 μm linear mixed-bed guard column followed by four Agilent PLgel MIXED-A 7.5×300 mm, 20-micron linear mixed-bed columns. The chromatographic solvent was 1,2,4-trichlorobenzene (TCB), which contained 200 ppm of butylated hydroxytoluene (BHT). The solvent source was nitrogen sparged. The injection volume used was 200 microliters, and the flow rate was 1.0 milliliters/minute.

Calibration of the GPC column set was performed usingAgilent EasiCal Polystyrene standards (EasiCal PS-1 and EasiCal PS-2). Each EasiCal system consisted of two different spatulas supporting a mixture of 5 polymer standards (approximately 5 mg) to obtain 20 molecular weights points ranging from approximately 580 to 6,570,000 g/mole. Individual spatulas were added to septa-capped vials, sealed and loaded into the PolymerChar autosampler. PolymerChar Instrument Control Software was utilized to add 8 mL of solvent to each vial and the standards were dissolved for 15 minutes at 1602 Celsius under high-speed shaking prior to injection to the chromatography system. The polystyrene standard peak molecular weights were converted to polyethylene molecular weights using Equation 1 (as described in Williams and Ward, J. Polym. Sci., Polym. Let., 6, 621 (1968)):

$${M}_{polyethylene} = A \times {( {M}_{polystyrene} )}^{B} , \qquad ( EQ 1 )$$

where M is the molecular weight, A has a value of 0.4315 and B is equal to 1.0.

A third order polynomial was used to fit the respective polyethylene-equivalent calibration points. A small adjustment to A (from approximately 0.375 to 0.445) was made to correct for column resolution and band-broadening effects, such that linear low-density polyethylene standard is obtained at 120,000 Mw. The total plate count of the GPC column set was performed with decane (3% v/v in TCB introduced via micropump.) The plate count (Equation 2) and symmetry (Equation 3) were measured on a 200 microliter injection according to the following equations:

$$Plate Count = 5.54 * {( \frac{( {RV}_{Peak Max} )}{Peak Width at \frac{1}{2} height} )}^{2} , \qquad ( EQ 2 )$$

where RV is the retention volume in milliliters, the peak width is in milliliters, the peak max is the maximum height of the peak, and ½ height is ½ height of the peak maximum; and

$$Symmetry = \frac{( Rear Peak {RV}_{one tenth height} - {RV}_{Peak max} )}{( {RV}_{Peak max} - Front Peak {RV}_{one tenth height} )} , \qquad ( EQ 3 )$$

where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a septa-capped vial, via the PolymerChar high temperature autosampler. The samples were dissolved for two hours at 1602 Celsius under “high speed” shaking.

The calculations of Mn_{(GPC)}, Mw_{(GPC)}, and Mz_{(GPC)} were based on GPC results using the internal IRS detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{\sum }^{i} {IR}_{i}}{{\sum }^{i} ( {IR}_{i} / {M}_{polyethyle {ne}_{i}} )} , \qquad ( EQ 4 )$$

$$\begin{matrix}{Mw}_{( GPC )} = \frac{{\sum }^{i} ( {IR}_{i} * {M}_{{polyethylene}_{i}} )}{{\sum }^{i} {IR}_{i}} \\ and\end{matrix} , \qquad ( EQ 5 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} . \qquad ( EQ 6 )$$

In order to monitor the deviations over time, a flowrate marker (decane) was introduced into each sample, via a micropump controlled with the PolymerChar GPC-IR system. This flowrate marker (FM) was used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak were then assumed to be related to a linear-shift in flowrate (Flowrate(effective)) for the entire run. To facilitate the highest accuracy of a RV measurement of the flow marker peak, a least-squares fitting routine was used to fit the peak of the flow marker concentration chromatogram to a quadratic equation. The first derivative of the quadratic equation was then used to solve for the true peak position. After calibrating the system, based on a flow marker peak, the effective flowrate (with respect to the narrow standards calibration) was calculated as Equation 7: Flowrate(effective)=Flowrate(nominal)*(RV(FM Calibrated)/RV(FM Sample)) (EQ7). Processing of the flow marker peak was done via the PolymerChar GPCOne™ Software. Acceptable flowrate correction is such that the effective flowrate should be within +/−0.7% of the nominal flowrate.

Moving die rheometer (MDR). Cure assessment of samples was conducted using Alpha Technologies Advanced Polymer Analyzer (APA 2000) at a designated temperature for 30 min with a 0.5° arc according to ASTM D5289-12, Standard Test Method for Rubber Property—Vulcanization Using Rotorless Cure Meters. The test was run at a frequency of 100 cycles per minute (cpm). Designate the lowest measured torque value as “ML”, expressed in deciNewton-meter (dN-m). As curing or crosslinking progresses, the measured torque value increases, eventually reaching a maximum torque value. Designate the maximum or highest measured torque value as “MH”, expressed in dN-m. All other things being equal, the greater the MH torque value, the greater the extent of crosslinking. Determine the T90 crosslinking time as being the number of minutes required to achieve a torque value equal to 90% of the difference MH minus ML (MH-ML), i.e., 90% of the way from ML to MH. The shorter the T90 crosslinking time, i.e., the sooner the torque value gets 90% of the way from ML to MH, the faster the curing rate of the test sample. Conversely, the longer the T90 crosslinking time, i.e., the more time the torque value takes to get 90% of the way from ML to MH, the slower the curing rate of the test sample.

Melt Index. The melt index (or “I₂”) of an ethylene-based polymer is measured in accordance with ASTM D-1238, condition 190° C./2.16 kg (melt index 110 at 190° C./10.0 kg). The I₁₀/I₂ was calculated from the ratio of I₁₀ to the I₂. The melt flow rate MFR of a propylene-based polymer is measured in accordance with ASTM D-1238, condition 230° C./2.16 kg.

Nuclear Magnetic Resonance (NMR) Characterization ofTerpolymers. For ¹H NMR experiments, each sample was dissolved, in 5 mm NMR tubes, in tetrachloroethane-d₂. The concentration was approximately 100 mg/1.8 mL. Each tube was then heated in a heating block set at 110° C. The sample tube was repeatedly vortexed and heated to achieve a homogeneous flowing fluid. The ¹H NMR spectrum was taken on a VARIAN 500 MHz spectrometer. A standard single pulse 1H NMR experiment was performed. The following acquisition parameters were used: 60 seconds relaxation delay, 16-32 scans. All measurements were taken without sample spinning at 110° C. The ¹H NMR spectrum was referenced to “5.99 ppm” for the resonance peak of the solvent (residual protonated tetrachloroethane). ¹H NMR was used to determine the polymerized SiH comonomer content (wt %), in the ethylene-SiH polymer. The “wt % SiH monomer” was calculated based on the integration of SiMe proton resonances, versus the integration of CH₂ protons associated with ethylene units and CH₃ protons associated with octene units. The “wt % octene (or other alpha-olefin)” can be similarly determined by reference to the CH₃ protons associated with octene units (or other alpha-olefin).

SiH Conversion. SiH conversion is determined with FTIR-ATR. See FTIR-ATR test method. The percent (%) SiH conversion is described under the FTIR-ATR test method.

### DETAILED DESCRIPTION

The present disclosure provides a process. In an embodiment, the process includes melt blending, at a temperature from 80° C. to 200° C., a composition composed of (i) an ethylene-SiH polymer, (ii) a crosslink agent that is 1,3-dibenzoylpropane, (iii) a triarylborane, and (iv) an alkylamine inhibitor. The process further includes forming a crosslinked ethylene-Si polymer.

The process includes melt blending, at a temperature from 80° C. to 200° C., a composition composed of (i) an ethylene-SiH polymer, (ii) a crosslink agent that is 1,3-dibenzoylpropane, (iii) a triarylborane, and (iv) an alkylamine inhibitor. The ethylene-SiH polymer is composed of (1) ethylene monomer, (2) from 0.1 wt % to 3.9 wt % of a SiH comonomer, and (3) optional C₃-C₁₂ α-olefin or C₄-C₈ α-olefin termonomer. An “SiH comonomer,” (interchangeably referred to as “SiH”) as used herein, is a silane monomer of Formula 1:

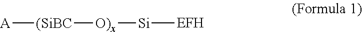

wherein A is an alkenyl group,
B is a hydrocarbyl group or hydrogen,
C is a hydrocarbyl group or hydrogen, and
wherein B and C may be the same or different, and further B is a hydrocarbyl group, C is a hydrocarbyl group, and further B and C are the same;
H is hydrogen, and x≥0;
E is a hydrocarbyl group or hydrogen,
F is a hydrocarbyl group or hydrogen, E and F may be the same or different, and when E is a hydrocarbyl group F is a hydrocarbyl group, E and F may be the same hydrocarbyl group. Nonlimiting samples of suitable SiH comonomer of Formula 1 include compounds s1) (allyldimethylsilane), s2) (propenyldimethylsilane), s3) (butenyldimethylsilane), s4) (hexenyldimethylsilane), s5) (octenyldimethylsilane), s6), (decenyldimethylsilane), s7) norbornylethyldimethylsilane, s8) octahydrodimethanonaphthalenylethyldimethysilane, s9) vinyltetramethyldisiloxane, s10) allyltetramethyldisiloxane, s11) _butenyltetramethyldisiloxane, s12, hexenyltetramethyldisiloxane, s13) octenyltetramethyldisiloxane, s14) decenyltetramethyldisiloxane, s15) norbornylethyltetramethyldisiloxane, s16) octahydrodimethanonaphthalenylethyltetramethyldisiloxane below:

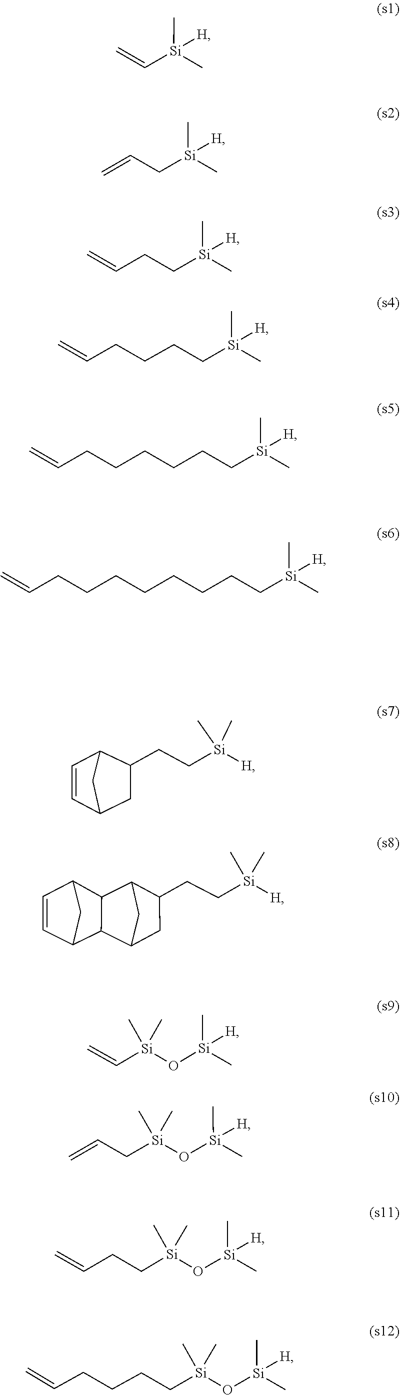

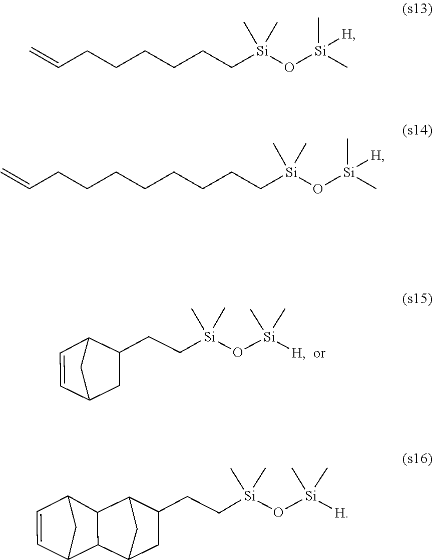

In an embodiment, the SiH comonomer is selected from allyldimethylsilane, hexenyldimethylsilane, octenyldimethylsilane, and hexenyltetramethyldisiloxane.

In an embodiment, the ethylene-SiH polymer is an ethylene/α-olefin/SiH terpolymer. The α-olefin in the ethylene/α-olefin/SiH comonomer terpolymer can be a C₃-C₁₂ α-olefin or a C₄-C₈ α-olefin. Nonlimiting examples of suitable α-olefin include propylene, butene, hexene, octene, and ethylidene norbornene for respective ethylene/propylene SiH terpolymer, ethylene/butene/SiH terpolymer, ethylene/hexene/SiH terpolymer, ethylene/octene/SiH terpolymer and ethylene/ethylidene norbornene/SiH terpolymer.

In an embodiment, the ethylene/α-olefin/SiH terpolymer is an ethylene/octene/SiH terpolymer. Nonlimiting examples of suitable ethylene/octene/SiH terpolymer include ethylene/octene/hexenyldimethylsilane (HDMS) terpolymer, ethylene/octene/octenyldimethylsilane (ODMS) terpolymer, and combinations thereof.

In an embodiment, the ethylene/α-olefin/SiH terpolymer is an ethylene/octene/SiH terpolymer. The ethylene/octene/SiH terpolymer includes from 30 wt % to 41 wt % octene, and from 0.5 w % to 5 wt %, or from 1.0 wt % to 3.5 wt % SiH comonomer and has a density from 0.87 g/cc to 0.89 g/cc, and an MI from 1 g/10 min to 18 g/10 min, or from 2 g/10 min to 12 g/10 min. Nonlimiting examples of suitable ethylene/octene/SiH terpolymer include ethylene/octene/allyldimethylsilane (ADMS) terpolymer, ethylene/octene/hexenyldimethylsilane (HDMS) terpolymer, and ethylene/octene/octenyldimethylsilane (ODMS) terpolymer.

In an embodiment, the ethylene-SiH polymer is ethylene/octene/hexenyldimethylsilane.

In an embodiment, the ethylene-SiH polymer is an ethylene/octene/ODMS terpolymer.

The composition includes a crosslink agent. The crosslink agent is 1,3-dibenzoylpropane.

The composition includes a triaryl borane. The three aryl groups of the triaryl borane may be the same or different. Each of the three aryl groups independently may include one, or two, or three, or four, or five substituents selected from hydrogen, chlorine, fluorine, trifluoromethyl groups, and combinations thereof. The triarylborane is a Lewis acid catalyst and promotes the hydrosilylation reaction between the SiH monomer of the ethylene-SiH polymer and the carbonyl groups of the 1,3-dibenzoylpropane. Nonlimiting examples of suitable triarylborane include tris(pentafluorophenyl)borane (FAB), tris(3,5-bis(trifluoromethyl)phenyl)borane; bis(3,5-bis(trifluoromethyl)phenyl)(2,4,6-trifluorophenyl)borane; bis(3,5-bis(trifluoromethyl)phenyl)(2,5-bis(trifluoromethyl)phenyl)borane; bis(3,5-bis(trifluoromethyl)phenyl)(4-trifluoromethylphenyl)borane, bis(3,5-bis(trifluoromethyl)phenyl)(2,6-difluorophenyl)borane, tris(2,5-bis(trifluoromethyl)phenyl)borane, and combinations thereof.

The composition includes an alkylamine inhibitor. The alkylamine inhibitor is a C₂-C₁₆ alkylamine, or a C₃-C₁₂ alkylamine. The alkylamine inhibitor may be a linear alkylamine, a branched alkylamine, or a cyclic alkylamine structure. The alkylamine inhibitor binds to the borane catalyst and prevents the borane catalyst from interacting with the Si—H thereby rendering the borane catalytically inactive. Upon heating, the amine-borane complex decomposes and releases free borane which is able to catalyze the reaction. Nonlimiting examples of suitable C₂-C₁₆alkylamine inhibitors include triethylamine, diisopropylamine, di-n-propylamine, tert-octylamine, n-octylamine, 2-amino-2,4,4-trimethylpentane, 2-aminoheptane, piperidine, 2,6-dimethylpiperidine, 2,2,6,6-tetramethylpiperidine, and combinations thereof.

The (i) ethylene-SiH polymer, (ii) the crosslink agent that is 1,3-dibenzoylpropane, (iii) the triarylborane, and (iv) the alkylamine inhibitor are melt blended, or otherwise mixed, at a temperature and for a length of time sufficient to fully homogenize the mixture. Melt blending is conducted by way of batch mixing or continuous mixing at a temperature from 80° C. to 200° C., or from 90° C. to 150° C., or from 100° C. to 120° C. for 1 minute to 20 minutes, or from 2 minutes to 15 minutes, or from 3 minutes to 10 minutes. The melt blending, in the presence of the triarylborane catalyst, initiates a hydrosilylation reaction between the Si—H moiety of the ethylene-SiH polymer and the carbonyl group of the 1,3-dibenzoylpropane, thereby bonding, or otherwise crosslinking polymer chains of the ethylene-SiH polymer with 1,3-dibenzoylpropane linkages to form a crosslinked ethylene-Si polymer. The alkylamine inhibitor binds to the borane catalyst and prevents the borane catalyst from interacting with the Si—H thereby rendering the borane catalytically inactive. Upon heating, the amine-borane complex decomposes and releases free borane which is able to catalyze the reaction. A “crosslinked ethylene-Si polymer,” as used herein, is the reaction product between the ethylene-SiH polymer and the 1-3-dibenzoylpropane whereby Si—O—C linkages crosslink, or bond, individual chains of ethylene-SiH polymer to each other.

In an embodiment, the crosslinked ethylene-Si polymer is the reaction product between the ethylene-SiH polymer and the 1-3-dibenzoylpropane whereby a Structure (1) is a linkage that crosslinks, or bonds, individual chains of ethylene-SiH polymer to each other:

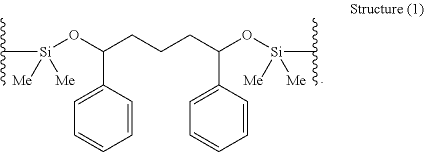 [SMILES: *[Si](C)(C)OC(CCCC(O[Si](*)(C)C)c1ccccc1)c1ccccc1]

In an embodiment, the crosslinked ethylene-Si polymer includes the linkage of Structure (1) to form a crosslinked polymer network having Structure (2) below

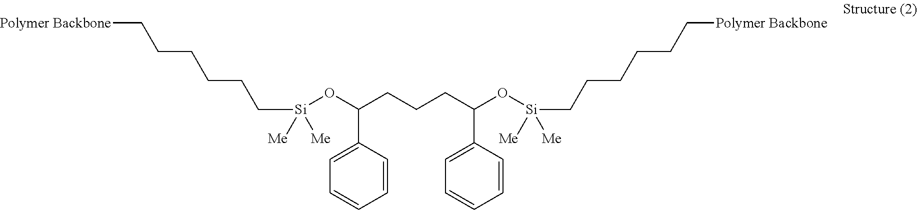

wherein the term “polymer” in Structure (2) indicates the individual chains of the ethylene-SiH polymer.

In an embodiment, melt blending is conducted by way of batch mixing in a batch mixer. The (i) ethylene-SiH polymer, (ii) the crosslink agent that is 1,3-dibenzoylpropane, (iii) the triarylborane, and (iv) the alkylamine inhibitor are added to a batch mixer and melt blended, or otherwise mixed, at a temperature from 80° C. to 200° C., or from 90° C. to 150° C., or from 100° C. to 120° C. for 1 minute to 20 minutes, or from 2 minutes to 15 minutes, or from 3 minutes to 10 minutes. Nonlimiting examples of suitable batch mixers include a BANBURY™ mixer, a BOLLING™ mixer, or a HAAKE™ mixer. The batch mixing forms a crosslinked ethylene-Si polymer with the Structure (1) and/or the Structure (2).

In an embodiment, melt blending is conducted by way of continuous mixing in an extruder. The (i) ethylene-SiH polymer, (ii) the crosslink agent that is 1,3-dibenzoylpropane, (iii) the triarylborane, and (iv) the alkylamine inhibitor are introduced into an extruder and melt blended, or otherwise mixed, at a temperature from 80° C. to 200° C., or from 90° C. to 150° C., or from 100° C. to 120° C. for 1 minute to 20 minutes, or from 2 minutes to 15 minutes, or from 3 minutes to 10 minutes to form a homogeneous composition. The extruder can be a continuous single screw extruder or a continuous twin screw extruder. Nonlimiting examples of suitable extruders include a FARREL™ continuous mixer, a COPERION™ twin screw extruder, or a BUSS™ kneading continuous extruder. The homogeneous composition exits an exit die of the extruder as an extrudate that is a functionalized ethylene-Si polymer with the Structure (1) and/or the Structure (2).

In an embodiment, the process includes the composition composed of (i) the ethylene-SiH polymer, (ii) the crosslink agent that is 1,3-dibenzoylpropane, (iii) the triarylborane, and (iv) the alkylamine inhibitor. The ethylene-SiH polymer contains Si atoms present in the SiH comonomer. The 1,3-dibenzoylpropane contains carbonyl moieties. The “Si:carbonyl mole ratio,” as used herein, is the ratio of moles of Si atoms in the ethylene-SiH polymer to the moles of carbonyl groups in the 1,3-dibenzoylpropane. The process includes providing a composition with components (i)-(iv) and having a Si:carbonyl mole ratio from 0.75:1 to 1:1 to 1.25:1, and melt blending the composition at a temperature from 80° C. to 200° C. and forming a crosslinked ethylene-Si polymer. The crosslinked ethylene-Si polymer has the Structure (1) and/or the Structure (2).

In an embodiment, the process includes the composition composed of (i) the ethylene-SiH polymer, (ii) the crosslink agent that is 1,3-dibenzoylpropane, (iii) the triarylborane, and (iv) the alkylamine inhibitor. A “alkylamine:triarylborane mole ratio,” as used herein, is the ratio of moles of alkylamine inhibitor to the moles of triarylborane in the composition. The process includes providing a composition with components (i)-(iv) having an alkylamine:triarylborane ratio from 1:1 to 2:1, (alone, or in combination with providing the composition with components (i)-(iv) and having a Si:carbonyl mole ratio from 0.75:1 to 1:1 to 1.25:1 (Si:carbonyl mole ratio 1.0+/−0.25), melt blendingthe composition at a temperature from 80° C. to 200° C. and forming a crosslinked ethylene-Si polymer. The crosslinked ethylene-Si polymer has the Structure (1) and/or the Structure (2).

In an embodiment, the process includes melt blending at a temperature from 80° C. to 200° C., or from 90° C. to 150° C., or from 100° C. to 120° C. for 1 minute to 20 minutes, or from 2 minutes to 15 minutes, or from 3 minutes to 10 minutes, a composition composed of (i) from 93 wt % to 98 wt % an ethylene/α-olefin/—SiH terpolymer, (ii) from 1 wt % to 10 wt %, or from 3 wt % to 8 wt % of the crosslink agent that is 1,3-dibenzoylpropane, (iii) from 5 ppm to 5000 ppm, or from 50 ppm to 500 ppm of the trialkylborane, and (iv) from 5-500 ppm, or from 10 ppm to 200 ppm of the alkylamine and the composition has a Si:carbonyl mole ratio from 0.75:1 to 1:1 to 1.25:1 (Si:carbonyl mole ratio 1.0+/−0.25), and an alkylamine:triarylborane ratio from 1:1 to 2:1. Weight percent is based on total weight of the composition. The process further includes forming a crosslinked ethylene-Si polymer. The crosslinked ethylene-Si polymer has the Structure (1) and/or the Structure (2).

The present disclosure provides a composition. In an embodiment, the composition includes a crosslinked ethylene-Si polymer having the Structure (1)

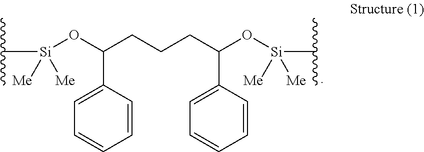 [SMILES: *[Si](C)(C)OC(CCCC(O[Si](*)(C)C)c1ccccc1)c1ccccc1]

The crosslinked ethylene-Si polymer with Structure (1) has one, some, or all of the following properties:
(i) a density from 0.86 g/cc to 0.88 g/cc, and/or
(ii) a M_{H}-M_{L} from 1 dN*m to 3.5 dN*m, and/or
(iii) from 3500 ppm to 5100 ppm silicon atom, and/or
(iv) from 1 ppm to 10 ppm boron atom.

In an embodiment, the composition includes a crosslinked ethylene-Si polymer having the Structure (2)

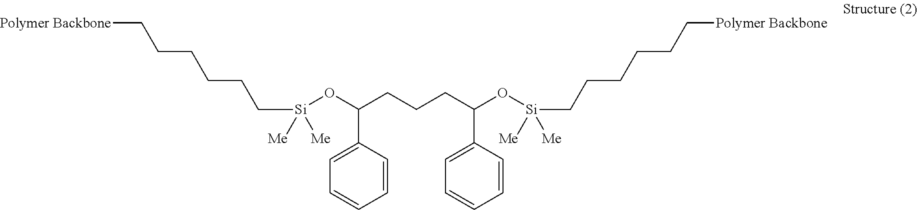

wherein the term “polymer” in Structure (2) indicates the individual chains of the ethylene-SiH polymer.

Applicant discovered that upon heating, the alkylamine inhibitor breaks down and releases the triarylborane as catalyst to react with the ethylene-SiH polymer and the crosslink agent (which is a di-functional crosslink agent) yielding a crosslinked network. Without the alkylamine inhibitor, the crosslinking reaction is uncontrollable leading to a loss of processability, which is detrimental to producing a finished part. Applicant further discovered that the temperature to produce crosslinking was tunable based on the type of alkylamine inhibitor used.

By way of example, and not limitation, some embodiments of the present disclosure will now be described in detail in the following examples.

### Examples

### A. Syntheses of Polymers P1, P2, and P3 and Properties

The ethylene/octene/silane co-polymerizations to produce polymers (ethylene-SiH polymer) were conducted in a batch reactor designed for ethylene homo-polymerizations and co-polymerizations. The reactor was equipped with electrical heating bands, and an internal cooling coil containing chilled glycol. Both the reactor and the heating/cooling system were controlled and monitored by a process computer. The bottom of the reactor was fitted with a dump valve, which emptied the reactor contents into a dump pot that was vented to the atmosphere. All chemicals used for polymerization and the catalyst solutions were run through purification columns prior to use. The ISOPAR-E, 1-octene, ethylene, and silane monomers were also passed through columns. Ultra-high purity grade nitrogen (Airgas) and hydrogen (Airgas) were used. The catalyst cocktail was prepared by mixing, in an inert glove box, the scavenger (MMAO), activator (bis(hydrogenated tallow alkyl)methyl tetrakis(pentafluoro-phenyl)borate(1<->) amine), and catalyst with the appropriate amount of toluene, to achieve a desired molarity solution. The solution was then diluted with ISOPAR-E or toluene to achieve the desired quantity for the polymerization, and drawn into a syringe for transfer to a catalyst shot tank.

In a typical polymerization, the reactor was loaded with ISOPAR-E, and 1-octene via independent flow meters. The silane monomer was then added via a shot tank piped in through an adjacent glove box. After the solvent/comonomer addition, hydrogen (if desired) was added, while the reactor was heated to a polymerization setpoint of 120° C. The ethylene was then added to the reactor via a flow meter, at the desired reaction temperature, to maintain a predetermined reaction pressure set point. The catalyst solution was transferred into the shot tank, via syringe, and then added to the reactor via a high pressure nitrogen stream, after the reactor pressure set point was achieved. A run timer was started upon catalyst injection, after which, an exotherm was observed, as well as a decrease in the reactor pressure, to indicate a successful run.

Ethylene was then added using a pressure controller to maintain the reaction pressure set point in the reactor. The polymerizations were run for set time or ethylene uptake, after which, the agitator was stopped, and the bottom dump valve was opened to empty the reactor contents into dump pot. The pot contents were poured into trays, which were placed in a fume hood, and the solvent was allowed to evaporate overnight. The trays containing the remaining polymer were then transferred to a vacuum oven, and heated to 100° C., under reduced pressure, to remove any residual solvent. After cooling to ambient temperature, the polymers were weighed for yield/efficiencies, transferred to containers for storage, and submitted for analytical testing.

TABLE 1A

| | Silane monomer (wt %) |
|---|---|
| Polymer 1 | 2.17 |
| Polymer 2 | 2.64 |
| Polymer 3 | 3.09 |

TABLE 1B
Polymerization Conditions to Produce Ethylene-SiH Polymer

| | | | Reactor | Ethylene | Octene | Silane | Solvent | H₂ | Run |
|---|---|---|---|---|---|---|---|---|---|
| | | Reactor | Pressure | loaded | loaded | monomer | loaded | loaded | Time |
| Resin | Catalyst | Size | (psi) | (g) | (g) | loaded (g) | (g) | (mmol) | (min) |
| Polymer 1 | CAT 1 | 2 L | 145 | 12.7 | 51.6 | 4.6 | 599 | 11.2 | 15.2 |
| | CAT 1 | 2 L | 140 | 12.7 | 57.1 | 4.6 | 594 | 11.1 | 17.5 |
| | CAT 1 | 2 L | 113 | 12.6 | 55.9 | 4.6 | 596 | 11.1 | 24.7 |
| Polymer 2 | CAT 1 | 2 L | 115 | 12.6 | 51.6 | 4.6 | 582 | 11.1 | 2.9 |
| | CAT 1 | 2 L | 116 | 12.5 | 58.1 | 4.6 | 588 | 11.1 | 3.6 |
| Polymer 3 | CAT 1 | 2 L | 117 | 12.6 | 44.8 | 6 | 584 | 11.1 | 5.3 |
| | CAT 1 | 2 L | 116 | 12.6 | 37.5 | 6 | 598 | 11.2 | 5.2 |
| | CAT 1 | 2 L | 114 | 12.6 | 46.5 | 6 | 582 | 11.1 | 5.25 |

TABLE 1C
Polymer Properties (Conventional GPC)

| | Component | Mn | Mw | | Tm | Octene | Silane | Silane |
|---|---|---|---|---|---|---|---|---|
| Resin | wt %*** | (kg/mol) | (kg/mol) | Mw/Mn | (° C.) | (mol %)* | mol %* | wt %** |
| Polymer 1* | 26 | 61.3 | 135 | 2.2 | 60 | 11.7 | 0.52 | 2.24 |
| | 38 | 78.0 | 171 | 2.2 | 68 | 9.6 | 0.44 | 2.01 |
| | 36 | 68.8 | 154 | 2.2 | 64 | 10.7 | 0.49 | 2.17 |
| Polymer 2 | 58 | 50.0 | 110 | 2.2 | 61 | 11.7 | 0.59 | 2.51 |
| | 42 | 56.3 | 122 | 2.2 | 64 | 10.7 | 0.61 | 2.66 |
| Polymer 3 | 43 | 59.1 | 108 | 2.2 | 63 | 11.38 | 0.65 | 2.86 |
| | 11 | 52.3 | 117 | 2.2 | 79 | 7.95 | 0.69 | 3.31 |
| | 46 | 46.8 | 105 | 2.2 | 67 | 10.09 | 0.72 | 3.26 |

*Mol % silane and octene based on total moles of monomers in polymer, and determined by 1H NMR
**Wt % silane calculated from the mol %, and based on the weight of the interpolymer.
***Lots of polymer obtained from different reactor runs were blended to make Polymers 1-3. The wt % of the component in the blend is given here

TABLE 1D
Catalysts and co-catalysts

| Catalyst (CAT) | Description |
|---|---|
| PE CAT 1 (WO2012/ 027448) | 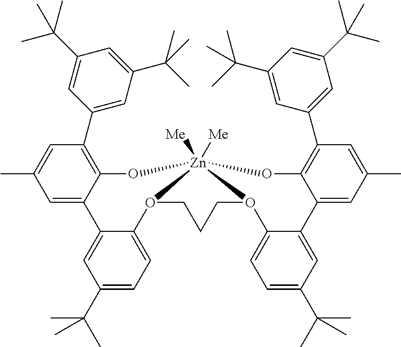 |
| Cocatalyst | |
| CoCAT-1 | A mixture of methyldi(C14-18 alkyl)ammonium salts of |
| | tetrakis(pentafluorophenyl)borate, prepared by reaction of a long chain |
| | trialkylamine (Armeen ™ M2HT, available from Akzo-Nobel, Inc.), HCl and |
| | Li[B(C6F5)4], substantially as disclosed in U.S. Pat. No. 5,919,983, Ex. 2 |
| | (no further purification performed) (Boulder Scientific) |
| CoCAT-2 | Modified methylalumoxane (MMAO) Type 3A (no further purification |
| | performed) (Akzo Nobel) |

### 1. Materials

Materials used in the comparative samples (CS) and in the inventive examples (IF) are provided in Table 2 below.

TABLE 2
Materials

| Ingredient | | Chemical Description, Chemical | |
|---|---|---|---|
| Type | Product Name | formula, or Structure | Source |
| Crosslink agent | 1,3-dibenzoylpropane (98%) | 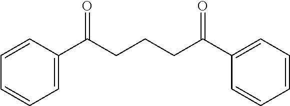 [SMILES: O=C(CCCC(=O)c1ccccc1)c1ccccc1] | Sigma- Aldrich |
| Triarylborane | Tris(pentafluorophenyl)borane | B(C₆F₅)₃, (FAB) | Sigma- |
| | (95%) | | Aldrich |
| Solvent | Toluene (anhydrous, 99.8%) | C₆H₅CH₃, PhCH₃, (PhMe) | Sigma- |
| | | | Aldrich |
| alkylamine | Triethylamine (≥99%) | N(CH₂CH₃)₃, (NEt₃) | Sigma- |
| Inhibitor | | | Aldrich |
| alkylamine | Diisopropylamine (≥99.5%) | [(CH₃)₂CH]₂NH, (iPr₂NH) | Sigma- |
| Inhibitor | | | Aldrich |
| alkylamine | Dipropylamine (99%) | (CH₃CH₂CH₂)₂NH, (Pr₂NH) | Sigma- |
| Inhibitor | | | Aldrich |
| alkylamine | tert-Octylamine (95%) | (CH₃)₃CHCH₂CH(CH₃)₂NH₂, (tOA) | Sigma- |
| Inhibitor | | | Aldrich |
| alkylamine | Octylamine (99%) | CH₃(CH₂)₆CH₂NH₂, (nOA) | Sigma- |
| Inhibitor | | | Aldrich |
| alkylamine | 2-Aminoheptane (99%) | CH₃(CH₂)₄CH(CH₃)NH₂, (2-AH) | Sigma- |
| Inhibitor | | | Aldrich |
| alkylamine Inhibitor | Piperidine (99%) | 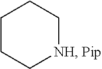 | Sigma- Aldrich |
| alkylamine Inhibitor | cis-2,6-Dimethylpiperidine (98%) | 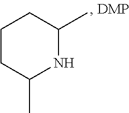 | Sigma- Aldrich |
| alkylamine Inhibitor | 2,2,6,6-Tetramethylpiperidine (≥99%) | 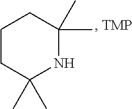 | Sigma- Aldrich |

### B. Melt Blending

The (i) ethylene-SiH polymer, (ii) 1,3-dibenzoylpropane (1,3-DBP), and (iii-iv) a FAB-alkylamine inhibitor solution in toluene were fed sequentially into a torque rheometer (Haake PolyLab QC, Thermal Scientific) equipped with a 20 mL bowl and two roller rotors at 100° C. After addition of each component, the sample was mixed at 60 rpm for 1 minute. The final blend was mixed for another 4 minutes (tₘᵢₓ=4+1=5 minutes). The hot melt was then removed from the blender and ready for further MDR testing.

Amounts and ratios for components (i)-(iv) in resultant formulations are provided in Table 3 below.

TABLE 3

| | IE1 | IE2 | IE3 | IE4 | IE5 | IE6 | IE7 |
|---|---|---|---|---|---|---|---|
| Polymer | Polymer | Polymer | Polymer | Polymer | Polymer | Polymer | Polymer |
| | 1 | 1 | 1 | 2 | 2 | 1 | 1 |
| ODMS wt % | 2.17 | 2.17 | 2.17 | 2.64 | 2.64 | 2.17 | 2.17 |
| ODMS (ppm) | 21700 | 21700 | 21700 | 26400 | 26400 | 21700 | 21700 |
| C═O in coagent/SiH | 1 | 1 | 1 | 1 | 1 | 1 | 1 |
| (mol/mol) | | | | | | | |
| Coagent (wt %) | 3.22 | 3.22 | 3.22 | 3.91 | 3.91 | 3.22 | 3.22 |
| Coagent (ppm) | 32167 | 32167 | 32167 | 39134 | 39134 | 32167 | 32167 |
| FAB (ppm) | 100 | 50 | 100 | 100 | 100 | 100 | 500 |
| Inhibitor | NEt₃ | NEt₃ | iPr₂NH | Pr₂NH | tOA | nOA | nOA |
| Inhibitor/catalyst | 1.2 | 1.2 | 1.2 | 1.2 | 1.2 | 1.2 | 1.2 |
| Inhibitor (ppm) | 24 | 12 | 24 | 24 | 30 | 30 | 151 |
| | CS1 | CS2 | CS3 | CS4 | CS5 | CS6 | CS7 |
| Polymer | Polymer | Polymer | Polymer | Polymer | Polymer | Polymer | Polymer |
| | 2 | 2 | 3 | 2 | 3 | 3 | 3 |
| ODMS wt % | 2.64 | 2.64 | 3.08 | 2.64 | 3.09 | 3.09 | 3.09 |
| ODMS (ppm) | 26400 | 26400 | 30800 | 26400 | 30900 | 30900 | 30900 |
| C═O in coagent/SiH | 1 | 1 | 1 | 1 | 1 | 1.5 | 0.5 |
| (mol/mol) | | | | | | | |
| Coagent (wt %) | 3.91 | 3.91 | 4.57 | 3.91 | 4.58 | 6.87 | 2.29 |
| Coagent (ppm) | 39134 | 39134 | 45656 | 39134 | 45805 | 68707 | 22902 |
| FAB (ppm) | 0 | 100 | 100 | 100 | 100 | 500 | 500 |
| Inhibitor | N/A | Pip | DMP | TMP | 2-AH | nOA | nOA |
| Inhibitor/catalyst | N/A | 1.2 | 1.2 | 1.2 | 1.2 | 1.2 | 1.2 |
| Inhibitor (ppm) | N/A | 20 | 26 | 33 | 27 | 151 | 151 |

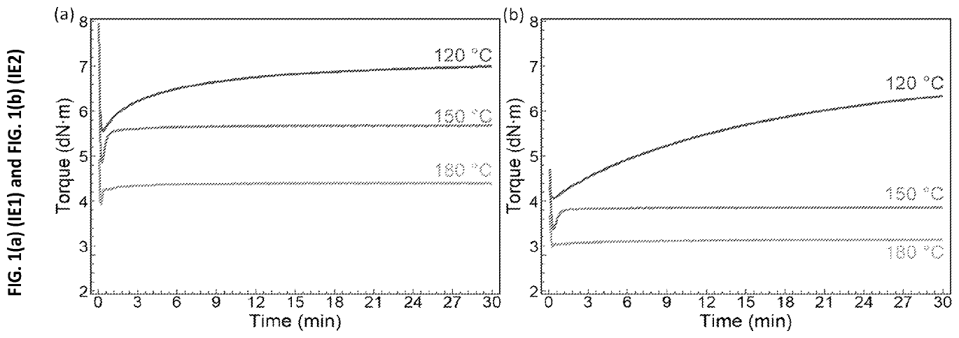

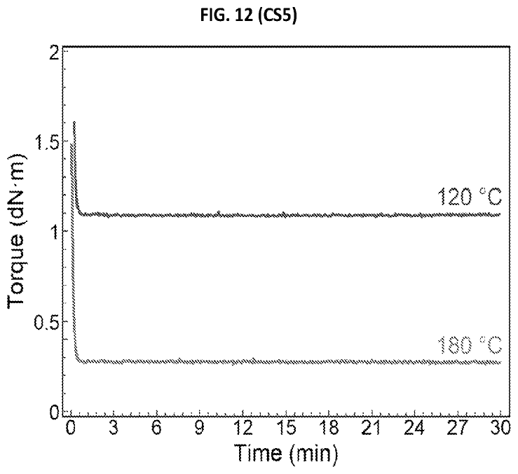

TABLE 4

| | | MH-ML (dN*m) | MH-ML (dN*m) | MH-ML (dN*m) | MH-ML (dN*m) |
|---|---|---|---|---|---|
| | Associated | Cure Temp: | Cure Temp: | Cure Temp: | Cure Temp: |
| Example | Figure | 120° C. | 150° C. | 180° C. | 200° C. |
| IE1 | FIG. 1a | 1.4 | 0.8 | 0.4 | — |
| IE2 | FIG. 1b | 2.3 | 0.4 | 0.2 | — |
| IE3 | FIG. 3 | 3.4 | 2.3 | 0.9 | — |
| IE4 | FIG. 5 | 2.4 | 1.7 | 0.6 | — |
| IE5 | FIG. 7 | 3.1 | 2.5 | 1.4 | — |
| IE6 | FIG. 9a | 0.2 | 0.4 | 0.6 | — |
| IE7 | FIG. 9b | — | — | 1.7 | 3.5 |
| CS1 | — | — | — | 0.0 | — |
| CS2 | FIG. 11 | — | — | 0.0 | — |
| CS3 | FIG. 11 | — | — | 0.0 | — |
| CS4 | FIG. 11 | — | — | 0.0 | — |
| CS5 | FIG. 12 | 0.0 | — | 0.0 | — |
| CS6 | — | — | — | 1.0 | — |
| CS7 | — | — | — | 0.4 | — |

*all samples cured for 30 min

FIG. 1(a) and 1(b). MDR profiles of 1,3-DBP samples containing FIG. 1(a) 100 ppm FAB (IE1) and FIG. 1(b) 50 ppm FAB (IE2) each sample inhibited by 1.2 eqv. NEt₃ at different temperatures. Both samples were compounded for 5 minutes at 100° C.

FIG. 1(a) shows cure profiles of NEt₃-inhibited samples containing 100 ppm FAB (IE1) at different temperatures. The lowest torque (M_{L}) of the sample decreased with an increase in the cure temperature, and a larger torque increase (M_{H}-M_{L}) was recorded at a lower cure temperature.

In FIG. 1(b) reducing the FAB loading to 50 ppm (IE2) significantly lowered M_{L} at a specific temperature compared to the FIG. 1(a) samples containing 100 ppm FAB, reflecting a lower cure level that had occurred in the compounding step. Overall, M_{H}-M_{L} of the sample showed the same temperature dependence as that of the 100 ppm FAB-NEt₃ sample. At 150° C. and 180° C., the cure times of the 50 ppm FAB-NEt₃ sample (FIG. 1(b)) was similar to those of the 100 ppm FAB-NEt₃ sample (FIG. 1(a)). Meanwhile, M_{H}-M_{L} of the 50 ppm FAB-NEt₃ sample (FIG. 1(b)) was smaller at each temperature, likely because under these conditions less catalyst was available for the cure reaction. Interestingly, at 120° C., the torque increase of the 50 ppm FAB-NEt₃ sample (FIG. 1(b)) within 30 minutes was larger than that of the 100 ppm FAB-NEt₃ sample (FIG. 1(a)) and the cure reaction showed no sign of completeness.

As shown in FIGS. 1(a) and 1(b), an embodiment of the present process includes melt blending, at a temperature from 120° C. to 180° C., or 120° C., a composition composed of (i) ethylene/octene/ODMS terpolymer, (ii) a crosslink agent that is 1,3-dibenzoylpropane, (iii) from 100 ppm to 50 ppm tris(pentafluorophenyl)borane, (iv) from 12 ppm to 24 ppm triethylamine, and forming a crosslinked ethylene-Si polymer having a M_{H}-M_{L} from 1 dN*m to 3 dN*m. The process includes forming a crosslinked ethylene-Si polymer having a M_{H}-M_{L} from of 1 dN*m when the composition contains 100 ppm FAB and 24 ppm triethylamine and is melt blended at a temperature of 120° C. The process includes forming a crosslinked ethylene-Si polymer having a M_{H}-M_{L} of 3 dN*m when the composition contains 50 ppm FAB and 12 ppm triethylamine and is melt blended at a temperature of 120° C.

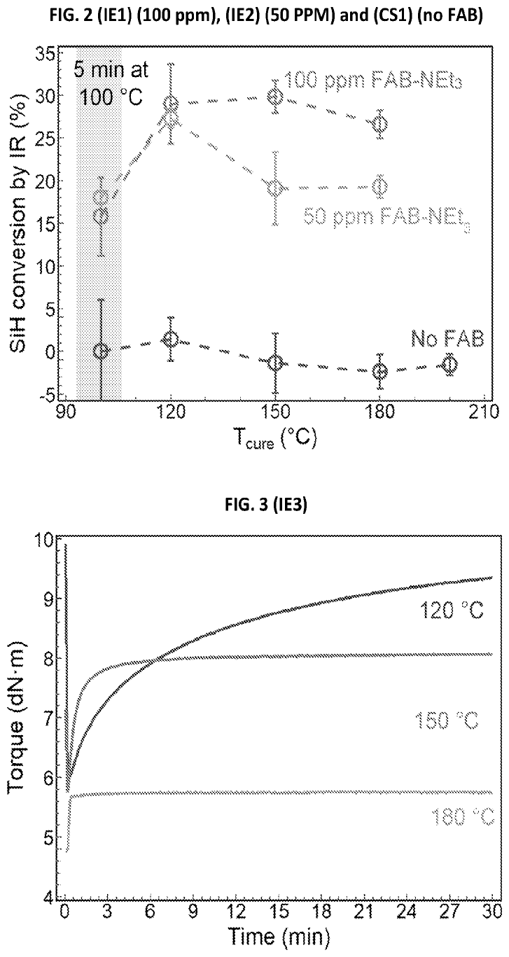

FIG. 2. SiH conversion of 1,3-DBP samples containing no FAB, 100 ppm FAB (IE1) and 50 ppm FAB (IE2) inhibited by 1.2 eqv. NEt₃ after 30 minutes at different cure temperatures. The datapoints at 100° C. represent SiH conversions in the as-compounded samples that were blended at 100° C. for 5 minutes. FIG. 2 shows that SiH conversions of the FAB-NEt₃ samples IE1 and IE2 was maximum when they were cured at 120° C., further confirming that the observed M_{H}-M_{L} difference of the FAB-NEt₃ samples at different temperatures was mainly due to a difference in the cure level.

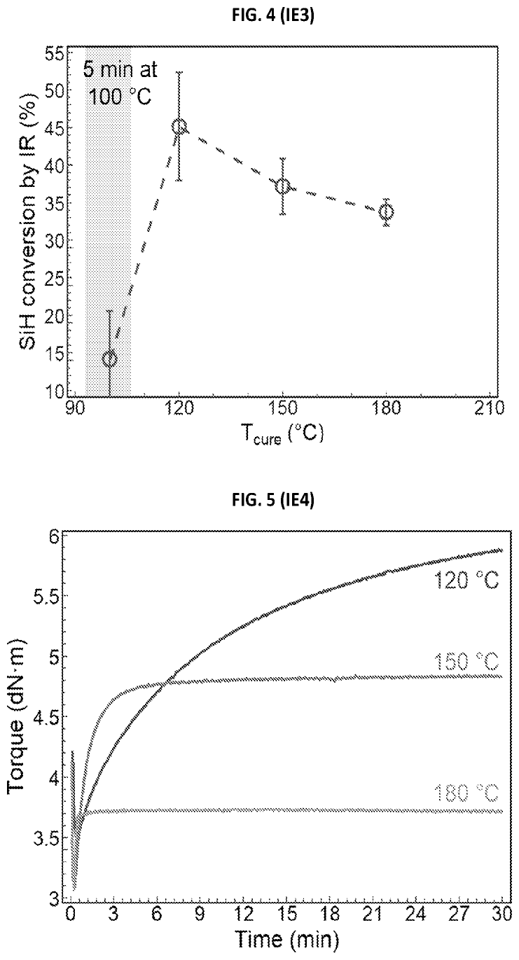

FIGS. 3-4. MDR profiles of 1,3-DBP samples containing 100 ppm FAB inhibited by 1.2 eqv. iPr₂NH (IE3) at different temperatures. FIG. 4. SiH conversion of a 1,3-DBP sample containing 100 ppm FAB inhibited by 1.2 eqv. iPr₂NH (IE3) at different temperatures. The datapoint at 100° C. represent the SiH conversion in the as-compounded sample that was blended at 100° C. for 5 minutes. M_{L} of the FAB-iPr₂NH sample increased nontrivially compared to that of the FAB-Pr₂NH one (FIG. 3). Nonetheless, both M_{H}-M_{L} and final SiH conversion (FIG. 4) of the FAB-iPr₂NH sample was higher than those of the FAB-Pr₂NH one at the same temperature.

As shown in FIGS. 3-4, iPr₂NH is an effective inhibitor that can cure from M_{H}-M_{L}1 dN*m to M_{H}-M_{L} 3 dN*m in the melt blend temperature range from 120° C. to 180° C., the latent cure exhibited for all temperatures 120° C.-180° C., with 120° C. providing the highest cure. An embodiment of the present process includes melt blending, at a temperature from 120° C. to 180° C., or 120° C., a composition composed of (i) ethylene/octene/ODMS terpolymer, (ii) a crosslink agent that is 1,3-dibenzoylpropane, (iii) 100 ppm tris(pentafluorophenyl)borane, and (iv) 24 ppm diisopropylamine, and forming a crosslinked ethylene-Si polymer having a M_{H}-M_{L} from 1 dN*m to 3 dN*m. The process includes forming a crosslinked ethylene-Si polymer having a M_{H}-M_{L}Of 1 dN*m when the composition contains 100 ppm FAB and 24 ppm diisopropylamine and is melt blended at a temperature of 180° C. The process includes forming a crosslinked ethylene-Si polymer having a M_{H}-M_{L} of 2 dN*m when the composition contains 100 ppm FAB and 24 ppm diisopropylamine and is melt blended at a temperature of 150° C. The process includes forming a crosslinked ethylene-Si polymer having a M_{H}-M_{L} of 3 dN*m when the composition contains 100 ppm FAB and 24 ppm diisopropylamine and is melt blended at a temperature of 120° C.

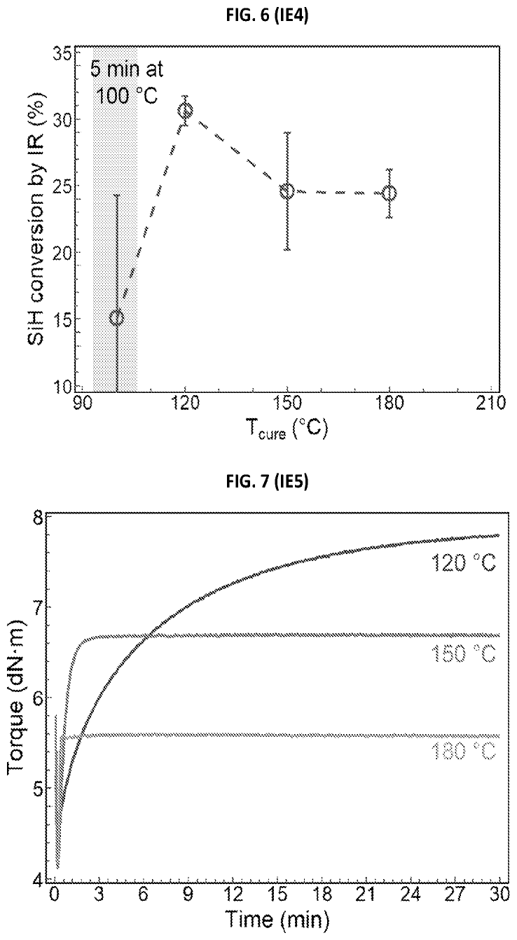

FIG. 5. MDR profiles of 1,3-DBP samples containing 100 ppm FAB inhibited by 1.2 eqv. Pr₂NH at different temperatures. FIG. 6. SiH conversion of a 1,3-DBP sample containing 100 ppm FAB inhibited by 1.2 eqv. Pr₂NH after 30 minutes at different temperatures. The datapoint at 100° C. represent the SiH conversion in the as-compounded sample that was blended at 100° C. for 5 minutes. Shown in FIG. 5 and FIG. 6, the Pr₂NH-inhibited sample (IE4) exhibited the same temperature-dependence of the cure profiles and SiH conversion as the FAB-NEt₃ samples (IE1-IE2). M_{L} of the sample was reduced, confirming stronger FAB inhibition provided by Pr₂NH than by NEt₃, and the torque increase was significantly higher than that of the FAB-NEt₃ samples especially at 150° C. and 180° C. An embodiment of the present process includes melt blending, at a temperature of 180° C., a composition composed of (i) ethylene/octene/ODMS terpolymer, (ii) a crosslink agent that is 1,3-dibenzoylpropane, (iii) 100 ppm tris(pentafluorophenyl)borane, and (iv) 24 ppm diisopropylamine, and forming a crosslinked ethylene-Si polymer having a M_{H}-M_{L} of 0.5 dN*m. The process includes forming a crosslinked ethylene-Si polymer having a M_{H}-M_{L} of 1.5 dN*m when the composition contains 100 ppm FAB and 24 ppm diisopropylamine and is melt blended at a temperature of 150° C. The process includes forming a crosslinked ethylene-Si polymer having a M_{H}-M_{L} of 3.0 dN*m when the composition contains 100 ppm FAB and 24 ppm diisopropylamine and is melt blended at a temperature of 120° C.

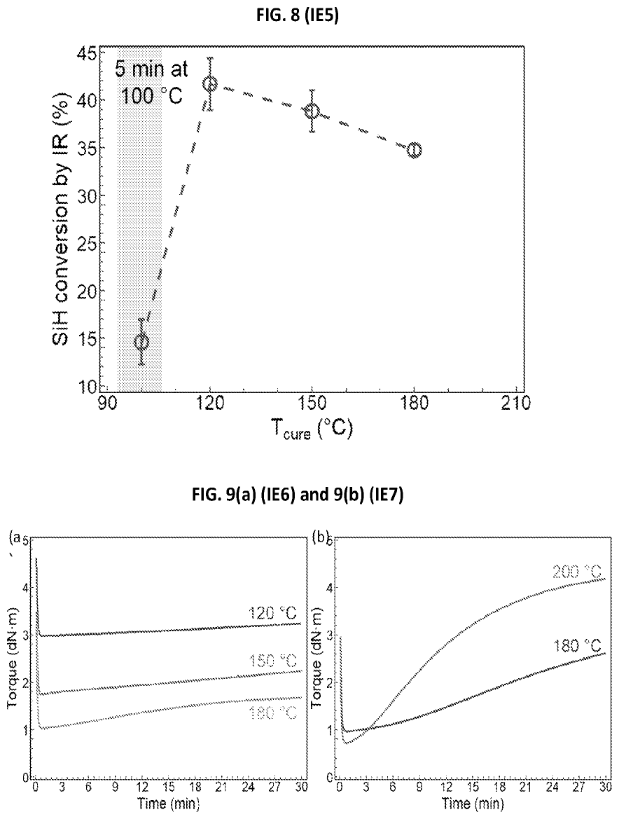

FIG. 7. MDR profiles of 1,3-DBP samples containing 100 ppm FAB inhibited by 1.2 eqv. tOA (IE5) at different temperatures. FIG. 8. SiH conversion of a 1,3-DBP sample containing 100 ppm FAB inhibited by 1.2 eqv. tOA (IE5) after 30 minutes at different temperatures. The datapoint at 100° C. represent the SiH conversion in the as-compounded sample that was blended at 100° C. for 5 minutes. At a 100 ppm FAB-tOA loading, M_{L} of the sample was lower and M_{H}-M_{L} was higher than that of the 100 ppm FAB-NEt₃ and 100 ppm FAB-iPr₂NH samples and higher than that of the 100 ppm FAB-Pr₂NH one (FIG. 7). Similarly, M_{H}-M_{L} and SiH conversion decreased with an increased cure temperature (FIG. 8). An embodiment of the present process includes melt blending, at a temperature from 120° C. to 180° C., a composition composed of (i) ethylene/octene/ODMS terpolymer, (ii) a crosslink agent that is 1,3-dibenzoylpropane, (iii) 100 ppm tris(pentafluorophenyl)borane, and (iv) 30 ppm tert-octyl amine, and forming a crosslinked ethylene-Si polymer having a M_{H}-M_{L} from 1.5 dN*m to 3.5 dN*m. The process includes forming a crosslinked ethylene-Si polymer having a M_{H}-M_{L} of 1.5 dN*m when the composition contains 100 ppm FAB and 30 ppm tert-octylamine and is melt blended at a temperature of 180° C. The process includes forming a crosslinked ethylene-Si polymer having a M_{H}-M_{L} of 2.5 dN*m when the composition contains 100 ppm FAB and 30 ppm tert-octylamine and is melt blended at a temperature of 150° C. The process includes forming a crosslinked ethylene-Si polymer having a M_{H}-M_{L} of 3.5 dN*m when the composition contains 100 ppm FAB and 30 ppm tert-octylamine and is melt blended at a temperature of 120° C.

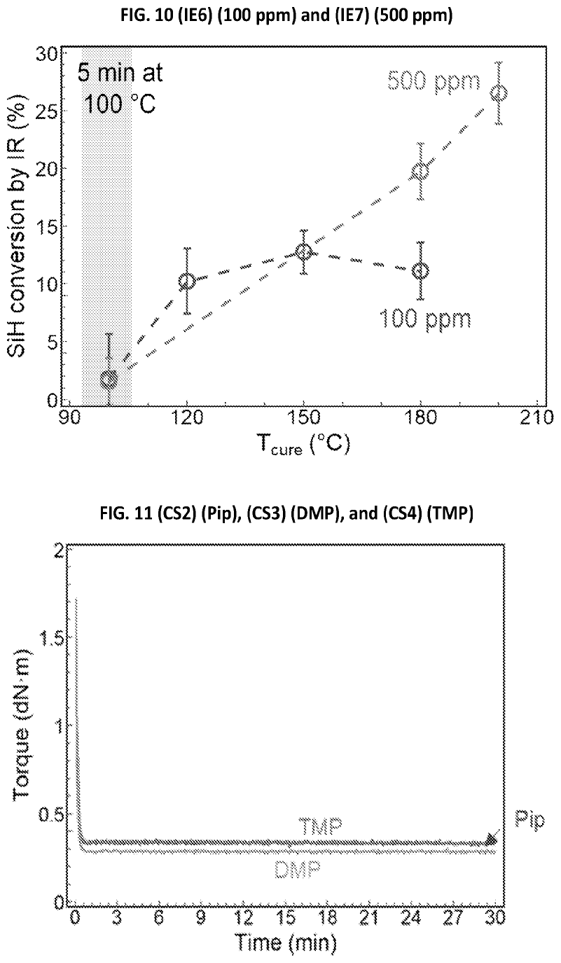

FIG. 9. MDR profiles of 1,3-DBP samples containing FIG. 9(a) 100 ppm FAB (IE6) and FIG. 9(b) 500 ppm FAB (IE7) inhibited by 1.2 eqv. nOA at different temperatures. The low M_{L} of the 100 ppm FAB-nOA sample at various temperatures showed little cure of the sample in the compounding step (FIG. 9(a)), suggesting strong FAB inhibition. Correspondingly, cure kinetics of the nOA-inhibited sample were relatively slow: the sample underwent minimal thermal cure under the test conditions (30 minutes at 120° C.-180° C.). FIG. 9(b) displays cure profiles of a 500 ppm FAB-nOA sample, which shows little extra sample cure in the compounding step compared to the case of 100 ppm FAB-nOA. The cure reaction was almost complete within 30 minutes at 200° C. Notably, the cure rate increased with temperature, and the cure level (M_{H}-M_{L}) increased correspondingly. IR results also indicate that SiH conversion increased with the cure temperature (FIG. 10).

An embodiment of the present process includes melt blending, at a temperature from 120° C. to 200° C., a composition composed of (i) ethylene/octene/ODMS terpolymer, (ii) a crosslink agent that is 1,3-dibenzoylpropane, (iii) 100 ppm tris(pentafluorophenyl)borane, and (iv) 30 ppm n-octyl amine, and forming a crosslinked ethylene-Si polymer having a M_{H}-M_{L} from 1.5 dN*m to 3.0 dN*m. The process includes forming a crosslinked ethylene-Si polymer having a M_{H}-M_{L} of 1.5 dN*m when the composition contains 100 ppm FAB and 30 ppm n-octylamine and is melt blended at a temperature of 180° C. The process includes forming a crosslinked ethylene-Si polymer having a M_{H}-M_{L} of 1.5 dN*m when the composition contains 100 ppm FAB and 30 ppm n-octylamine and is melt blended at a temperature of 150° C. The process includes forming a crosslinked ethylene-Si polymer having a M_{H}-M_{L}Of 3.0 dN*m when the composition contains 100 ppm FAB and 30 ppm n-octylamine and is melt blended at a temperature of 200° C.

FIG. 11. MDR profiles of 1,3-DBP samples containing 100 ppm FAB inhibited by 1.2 eqv. Pip (CS2), TMP (CS4), and DMP (CS3) at 180° C. When piperidine (Pip), 2,6-dimethylpiperidine (DMP), and 2,2,6,6-tetramethylpiperidine (TMP) were used as the FAB inhibitors, no thermal cure was observed at all as suggested by the very low M_{L} and zero torque increase (FIG. 11).

FIG. 12. MDR profiles of 1,3-DBP samples containing 100 ppm FAB inhibited by 1.2 Eqv. 2-AH (CS5) at different temperatures. When 2-AH was used as the FAB inhibitor, no cure occurred when the sample was subjected to 30 minutes heating at 120 and 180° C.

It is specifically intended that the present disclosure not be limited to the embodiments and illustrations contained herein, but include modified forms of those embodiments including portions of the embodiments and combination of elements of different embodiments as come within the scope of the following claims.

1. A process comprising:
melt blending, at a temperature from 80° C. to 200° C., a composition comprising
(i) an ethylene-SiH polymer,
(ii) a crosslink agent that is 1,3-dibenzoylpropane,
(iii) a triarylborane, and
(iv) an alkylamine inhibitor; and
forming a crosslinked ethylene-Si polymer.

2. The process of claim 1 comprising
providing a composition having an Si:carbonyl mole ratio from 0.75:1 to 1:1 to 1.25:1.

3. The process of claim 1 comprising
providing a composition having an alkylamine:triarylborane mole ratio from 1:1 to 2:1.

4. The process of claim 1 comprising
providing a composition comprising
(i) from 90 wt % to 99 wt % of an ethylene/α-olefin/—SiH terpolymer,
(ii) from 1 wt % to 10 wt % of the crosslink agent that is 1,3-dibenzoylpropane,
(iii) from 5 ppm to 5000 ppm of the triaryl borane, and
(iv) from 5-500 ppm of the alkylamine wherein the mole equivalent of the alkylamine:borane is from 1:1 to 2:1; and
forming a crosslinked ethylene-Si polymer.

5. The process of claim 1 comprising forming a crosslinked ethylene-Si polymer having Si—O—C bonds.

6. The process of claim 1 comprising forming a crosslinked ethylene-Si polymer having a Structure (1)

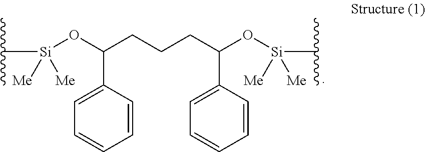 [SMILES: *[Si](C)(C)OC(CCCC(O[Si](*)(C)C)c1ccccc1)c1ccccc1]

7. The process of claim 1 comprising
melt blending, at a temperature of 120° C., a composition comprising
(i) an ethylene/octene/ODMS terpolymer,
(ii) a crosslink agent that is 1,3-dibenzoylpropane,
(iii) from 100 ppm to 50 ppm tris(pentafluorophenyl)borane,
(iv) from 12 ppm to 24 ppm triethylamine; and
forming a crosslinked ethylene-Si polymer having a M_{H}-M_{L} from 1 dN*m to 3 dN*m.

8. The process of claim 1 comprising
melt blending, at a temperature from 120° C. to 180° C., a composition comprising
(i) ethylene/octene/ODMS terpolymer,
(ii) a crosslink agent that is 1,3-dibenzoylpropane,
(iii) 100 ppm tris(pentafluorophenyl)borane,
(iv) 24 ppm diisopropylamine; and
forming a crosslinked ethylene-Si polymer having a M_{H}-M_{L} from 1 dN*m to 3 dN*m.

9. The process of claim 1 comprising
melt blending, at a temperature from 120° C. to 180° C., a composition comprising
(i) ethylene/octene/ODMS terpolymer,
(ii) a crosslink agent that is 1,3-dibenzoylpropane,
(iii) 100 ppm tris(pentafluorophenyl)borane,
(iv) 30 ppm tert-octylamine; and
forming a crosslinked ethylene-Si polymer having a M_{H}-M_{L} from 1.5 dN*m to 3.5 dN*m.

10. The process of claim 1 comprising
melt blending, at a temperature from 120° C. to 200° C., a composition comprising
(i) ethylene/octene/ODMS terpolymer,
(ii) a crosslink agent that is 1,3-dibenzoylpropane,
(iii) 100 ppm tris(pentafluorophenyl)borane,
(iv) 30 ppm n-octylamine; and
forming a crosslinked ethylene-Si polymer having a M_{H}-M_{L} from 1.5 dN*m to 3.0 dN*m.

11. A composition comprising:
a crosslinked ethylene-Si polymer having a Structure (1)

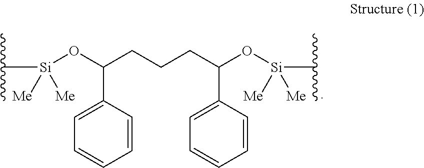 [SMILES: *[Si](C)(C)OC(CCCC(O[Si](*)(C)C)c1ccccc1)c1ccccc1]

12. The composition of claim 11 having a density from 0.86 g/cc to 0.88 g/cc.

13. The composition of claim 11 wherein the composition has a M_{H}-M_{L} from 1 dN*m to 5 dN*m.

14. The composition of claim 13 comprising from 1000 ppm to 6000 ppm silicon atom.

15. The composition of claim 13 comprising from 0.1 ppm to 100 ppm boron atom.

16. The composition of claim 13 wherein the crosslinked ethylene-Si polymer has a Structure (2) [chemical structure]
